(19) United States
(12) Patent Application Publication
(10) Pub. No.: US 2009/0179148 A1
(43) Pub. Date: Jul. 16, 2009

(54) MASS SPECTROMETER AND MASS SPECTROMETRY METHOD

(75) Inventors: Hiroyuki Yasuda, Hitachinaka (JP); Yasushi Terui, Tsuchiura (JP); Shinji Nagai, Hitachinaka (JP); Tetsuya Nishida, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi High-Technologies Corporation

(21) Appl. No.: 12/350,328

(22) Filed: Jan. 8, 2009

(30) Foreign Application Priority Data
Jan. 11, 2008 (JP) 2008-003808

(51) Int. Cl. B01D 59/44; H01J 49/00

(52) U.S. Cl. 250/282; 250/281

(57) ABSTRACT

Performing an MS3 with a tandem mass spectrometer causes problems of increase in size of the device and of increase in cost. Likewise, a plural number of times MS/MS analyses are even more difficult. An electrode to create a harmonic potential is disposed in a collision cell, and fragment ions produced by the first-time collision induced dissociation are accumulated in the harmonic potential. Target ions of the subsequent stage are let out, by means of an axial resonance excitation, selectively from the accumulated ions. The ions are excited in the axial direction to have a potential exceeding the harmonic potential. Thereby, the second-time collision induced dissociation is performed by means of a potential difference provided at the subsequent stage. In addition, an operation to return the ions back to the harmonic potential enables a plural number of times MS/MS analyses to be performed.

### CLAIM OF PRIORITY

The present application claims priority from Japanese application JP 2008-3808 filed on Jan. 11, 2008, the content of which is hereby incorporated by reference into this application.

### BACKGROUND OF THE INVENTION

1. Field of the Invention

The present invention relates to a mass spectrometer and a mass spectrometry method.

2. Description of the Related Art

The operation of mass spectrometric devices is based on the following operational principle. Firstly, sample molecules are electrically charged to be ionized. Ions thus produced are sorted according to their mass-to-charge ratios by means of an electric field or a magnetic field. The amount of each kind of ions thus sorted is measured in terms of the electric current by a detector. Mass spectrometric devices are sensitive, and excellent in the quantitative capability and in the identification capability in comparison to conventional analysis devices. In the field of life sciences, more attention has been recently paid to the peptide analysis and the metabolomics instead of the genome analysis. Consequently, the advantages of mass spectrometric devices that are sensitive and excellent in the identification capability and in the quantitative capability have been re-recognized.

There are various types of mass spectrometric devices classified in terms of the operational principle of each mass spectrometric device. The mass spectrometers that are mainly used today are: quadrupole mass spectrometers (QMSs); and time of flight mass spectrometer (TOFMSs).

Tandem mass spectrometer (tandem MS) is a generic name given to a mass spectrometric devices that performs mass separation after at least a round of isolation and collision induced dissociation. Examples of such devices that are capable of performing a round of isolation and collision induced dissociation include: quadrupole-time of flight mass spectrometers (Q-TOFs) and triple quadrupole mass spectrometers (Triple QMSs). Japanese Patent Application Publication No. 2005-353304 discloses a kind of tandem mass spectrometer that is referred to as a triple quadrupole mass spectrometer.

### SUMMARY OF THE INVENTION

In a tandem mass spectrometer called a quadrupole-time of flight mass spectrometer or a triple quadrupole mass spectrometer, ions are produced and immediately arrive at the detector. For this reason, the tandem mass spectrometer can only perform up to MS2. In addition, when a tandem mass spectrometer is designed to perform MS3, a collision cell of the second stage and a mass separator of the third stage have to be provided at the subsequent stage of the mass separator of the second stage. This brings about another problem of increase in the size of the device and of increase in cost. Likewise, it is more difficult to perform plural times of MSn. Ion trap mass spectrometers have another problem of being incapable of measuring fragment ions with lower mass. This is because, in this type of mass spectrometer, ions having a mass-to-charge ratio approximately equal to or smaller than a quarter of the mass-to-charge ratio of the target ion cannot be accumulated in the ion trap due to the influence of the electric field formed at the time of the collision induced dissociation.

Accordingly, an object of the present invention is to make MS3 possible by means of a mass spectrometric device with only a single collision cell.

In addition, another object of the present invention is to make a mass spectrometric device capable of performing plural times of MS/MS analyses while preventing a size increase of the device.

Moreover, still another object of the present invention is to make a mass spectrometric device capable of measuring fragment ions having a small mass-to-charge ratio

An aspect of the present invention provides a mass spectrometer including: an ion source that ionizes a sample; a first mass separator, using quadrupolar electric field or the like, that selectively transmits, accumulates, or ejects target ions from the ions produced by the ion source; a collision cell that performs a collision induced dissociation on the target ions by making the target ions collide with neutral molecules; an mass separator capable of performing mass separation on the ions on the basis of the mass-to-charge ratio of the ion; and a detector that converts the amount of arrived ions into the value of electric current. In the aspect of the present invention, a potential to accumulate ions is created inside the collision cell, and the collision induced dissociation is performed by means of the energy at the time of introduction and the energy at the time of ejection.

In another aspect of the present invention, a potential to accelerate the ions is formed after the potential to accumulate the ions. The acceleration energy is used for performing the second-time collision induced dissociation.

In another aspect of the present invention, a potential to accumulate ions is created using a vane electrode to create a harmonic potential at the earlier stage within the collision cell. Fragment ions produced at the time of introduction are accumulated. Energy for ejection is given only to the ions to be subjected to the MS3 by superimposing auxiliary AC voltage on the vane electrode. In this way, the second-time collision induced dissociation is performed.

In another aspect of the present invention, a vane electrode to give gradient electric field to give the acceleration energy is disposed at the subsequent stage of the vane electrodes to create a harmonic potential. In this way, the second-time collision induced dissociation is performed.

In another aspect of the present invention, a potential of the vane electrode to give gradient electric field that gives acceleration energy and a potential of the electrode provided at the subsequent stage are set at higher than a potential at an edge of the harmonic potential. Thus, ions are accelerated towards the harmonic potential, and the ions are accumulated again in the harmonic potential. By repeating the above-described operation a plural number of times, plural-time MS/MS analyses are performed.

In addition, another aspect of the present invention provides a mass spectrometer including: an ion source that ionizes a sample; an nth-stage (n is a natural number) mass separator that performs a mass separation in which target ions are isolated from the ions produced by the ion source; a collision cell that performs the mth-time (m is a natural number) collision induced dissociation on the isolated ions; an (n+1)th-stage mass separator that performs another mass separation on the fragment ions produced through the collision induced dissociation; and a detector that detects ions. In the mass spectrometer, a harmonic potential is created inside the collision cell, and the fragment ions produced through the collision induced dissociation are accumulated in the harmonic potential. Target ions selected from the fragment ions are selectively ejected in an axial direction, and an (m+1)th-time collision induced dissociation is performed by means of a potential difference provided at a later stage.

An advantageous effect of the present invention is that the target ions introduced into the collision cell are cleaved and are cleaved for the second time in the collision cell so that the MS3 can be performed with only one collision cell.

Another advantageous effect of the present invention is that performing an operation to return the ions back to the harmonic potential enables plural times of MS/MS analyses to be performed.

Still another advantageous effect of the present invention is that the collision induced dissociation performed in the collision cell enables the fragment ions of low mass-to-charge ratios to be measured.

The above-mentioned aspects and other aspects of the present invention will be described below.

### BRIEF DESCRIPTION OF THE DRAWINGS

FIG. 1 is a diagram illustrating a configuration of a quadrupole-time of flight mass spectrometer according to an embodiment of the present invention.

FIG. 2 is a timing chart according to the embodiment of the present invention.

FIG. 3 is a timing chart at the time of performing MS4 according to the embodiment of the present invention.

FIG. 4 is a diagram illustrating a configuration of a triple quadrupole mass spectrometer according to an embodiment of the present invention.

### DESCRIPTION OF THE PREFERRED EMBODIMENTS

To begin with, description will be given of various kinds of mass spectrometric devices. The operation of mass spectrometric devices is based on the following operational principle. Firstly, sample molecules are electrically charged to be ionized. Ions thus produced are sorted on the basis of their respective mass-to-charge ratios by means of an electric field or a magnetic field. The amount of each kind of ions thus sorted is measured in terms of the electric current by a detector. Mass spectrometric devices are sensitive, and excellent in the quantitative capability and in the identification capability in comparison to conventional analysis devices. In the field of life sciences, more attention has been recently paid to the peptide analysis and the metabolomics instead of the genome analysis. Consequently, the advantages of mass spectrometric devices that are sensitive and excellent in the identification capability and in the quantitative capability have been re-recognized.

There are various types of mass spectrometric devices classified in terms of the operational principle of each mass spectrometric device. The mass spectrometers that are mainly used today are: quadrupole mass spectrometers (QMSs); and time of flight mass spectrometer (TOFMSs).

A quadrupole mass spectrometer performs mass separation by applying a high-frequency voltage and a DC voltage to four columnar poles or four poles with hyperboloidal surfaces that serve as electrodes. With a quadrupolar electric field that is formed among the electrodes by the application of a high-frequency voltage, a pseudo potential well is formed and the ions are made to converge on the space among the electrodes. Superimposition of a DC voltage at this time allows the transmission of ions of a specific mass-to-charge ratio. The ions thus transmitted are transported to a detector, and thus the amount of the ions can be measured. Sweeping the DC voltage and an AC voltage at a voltage ratio that allows the transmission of a certain specified ion allows the ions of lower mass-to-charge ratio to arrive earlier at the detector. Thus, a mass spectrum can be obtained. Quadrupole mass spectrometers can perform a sequential measurement. In addition, the detector of the quadrupole mass spectrometer has a wider dynamic range, so that the quadrupole mass spectrometers have high quantitative capability.

A time of flight mass spectrometer performs mass separation by accelerating ions by means of an electric field and by then measuring the time that it takes for the ions to arrive at the detector. The acceleration energy that the electric field gives to the ions is constant, so that the time it takes for the ions to arrive at the detector differs in accordance with their respective mass-to-charge ratios. Specifically, ions of lower mass-to-charge ratios arrive at the detector earlier while ions of higher mass-to-charge ratios arrive at the detector later. A mass spectrum can be obtained by plotting values of the electric current outputted from the detector with respective to the time at which each ion arrives at the detector. Time of flight mass spectrometers have high mass resolution and high mass accuracy, so that the time of flight mass spectrometers have high qualitative capability.

When the mass spectrometric devices of the above two examples are used, different mass spectra are obtained from samples of different masses. From each of the mass spectra, information on the composition and the amount of the sample can be obtained. The composition of the sample, however, may sometimes be complex, or the mass spectrum thus obtained may sometimes give only insufficient information for identifying the composition of the sample. In particular, since mass spectrometric devices identify molecule ions by means of their respective mass-to-charge ratios, the discrimination of different molecule ions is difficult in the following cases: when molecule ions of different structures have the same mass-to-charge ratio; and when the resolution of the mass spectrometer is not good enough. In addition, in a mass spectrum of the mass-to-charge ratio of 400 or smaller, the amount of foreign substances from the solvent or from the environment may sometimes be too great to make the discrimination of the target component from the foreign materials possible. The MSⁿ analysis was worked out as a countermeasure for this problem.

The MSⁿ analysis is a method based on the following operational principle. Firstly, molecule ions are taken into the mass spectrometric device. Then, molecule ions of a particular mass-to-charge ratio are isolated, and the isolated molecule ions are made to collide with neutral molecules to break a part of the bonding of each molecule ion. The ions with the broken bonding are measured. The breaking of bondings in molecule ions achieved by making the molecule ions collide with neutral molecules is called “collision induced dissociation (CID).” The number of repeating a series of operations including the isolation and the collision induced dissociation is reflected on the nomenclature such as MS², MS³, or the like. Note that the bonding between atoms of molecules differs in the bonding energy because of the difference in the molecule structure or in the kind of bonding. Accordingly, a bonding with a lower bonding energy is more likely to be broken by collision induced dissociation. When a kinetic energy that is great enough to break the bondings is given to molecule ions at the collision of the molecule ions with neutral molecules, peculiar fragment ions are produced and thus make the identification of structure of the molecule ions possible. In addition, since the ions are firstly isolated and then cleaved, the mass-to-charge ratio range of the ions after the cleavage has small noise. An improvement is achieved in the ratio between the signal intensity and the noise (S/N ratio).

Tandem mass spectrometer (tandem MS) is a generic name given to a mass spectrometric devices that performs mass separation after at least a round of isolation and collision induced dissociation. Examples of such devices that are capable of performing a round of isolation and collision induced dissociation include: quadrupole-time of flight mass spectrometers (Q-TOFs) and triple quadrupole mass spectrometers (Triple QMSs).

A quadrupole-time of flight mass spectrometer is a device including a quadrupole mass spectrometer and a time of flight mass spectrometer combined together. The provision of a collision cell between the quadrupole mass spectrometer and the time of flight mass spectrometer makes it possible to perform an MS/MS. Collision induced dissociation takes place in the collision cell in the following way. Neutral molecules such as those of helium or of nitrogen are introduced into the collision cell so as to increase the internal pressure of the collision cell. Such an increase in the internal pressure makes the collision of the ions with the neutral molecules more likely to take place. After the target ions for the MS/MS are isolated from the sample by means of the quadrupole mass spectrometer, cleavage of the isolated ions are caused by the energy inputted into the collision cell. A MS/MS mass spectrum can be obtained through the mass separation performed on the cleaved ions by means of the time of flight mass spectrometer provided at the later stage. The use of the time of flight mass spectrometer as the mass separator makes it possible to obtain an MS/MS spectrum of high resolution and high mass accuracy. To put it differently, the result obtained by a quadrupole-time of flight mass spectrometer is reliable. Accordingly, quadrupole-time of flight mass spectrometers are frequently used in various identification analyses such as protein analyses.

A triple quadrupole mass spectrometer is a device including three quadrupole mass spectrometers combined together. The quadrupole mass spectrometer disposed in the middle serves as a collision cell. The structure of the collision cell and the principle of the collision induced dissociation are the same as their respective counterparts in the case of the above-described quadrupole-time of flight mass spectrometer. Ion isolation is performed by means of the quadrupole mass spectrometer of the first stage, the cleavage of ions is performed at the second stage, and the mass separation is performed at the third stage. The triple quadrupole mass spectrometer differs from the quadrupole-time of flight mass spectrometer in that the triple quadrupole mass spectrometer employs a quadrupole mass spectrometer as the mass separator. Accordingly, the use of the quadrupole mass spectrometer produces a result with high quantitative characteristics. As a consequence, quadrupole mass spectrometers are frequently used in quantitative analyses such as pharmacokinetic analyses.

An ion trap mass spectrometer is one of the mass spectrometric devices that make the MSⁿ analysis possible. An MS/MS spectrum can be obtained by means of an ion trap mass spectrometer in the following way. Firstly, ions are accumulated once in the quadrupolar electric field. Then, isolation by resonance excitation and collision induced dissociation are performed. After that, mass separation by unstable ejection or resonance excitation is performed. In the ion trap mass spectrometer, ions are accumulated. Cleaved ions are not ejected, but can be left in the ion trap electrodes. Accordingly, performing another round of isolation and collision induced dissociation makes plural times of MS/MS analyses possible.

Cleavage of ions through collision induced dissociation occurs more frequently in a portion where the intermolecular bonding is weaker. Accordingly, an MS/MS spectrum of insufficient information may sometimes be obtained for an ion with a complex structure. In this case, however, another round of isolation and collision induced dissociation is performed on the ions of insufficient information in plural times of MS/MS analyses. Accordingly, additional information to the insufficient one can be obtained. In practice, when identification and structure analysis are performed on a glycosylated peptide, the peptide sequence and the oligosaccharide chain structure can be analyzed at the same time in the following way. The peptide with weak bonding is cleaved and identified through the MS/MS, and then oligosaccharide chain fragments that are produced concurrently at the MS2 are selectively subjected to the MS3 analysis.

Embodiments of the present invention will be described below with reference to the accompanying drawings.

### Embodiment 1

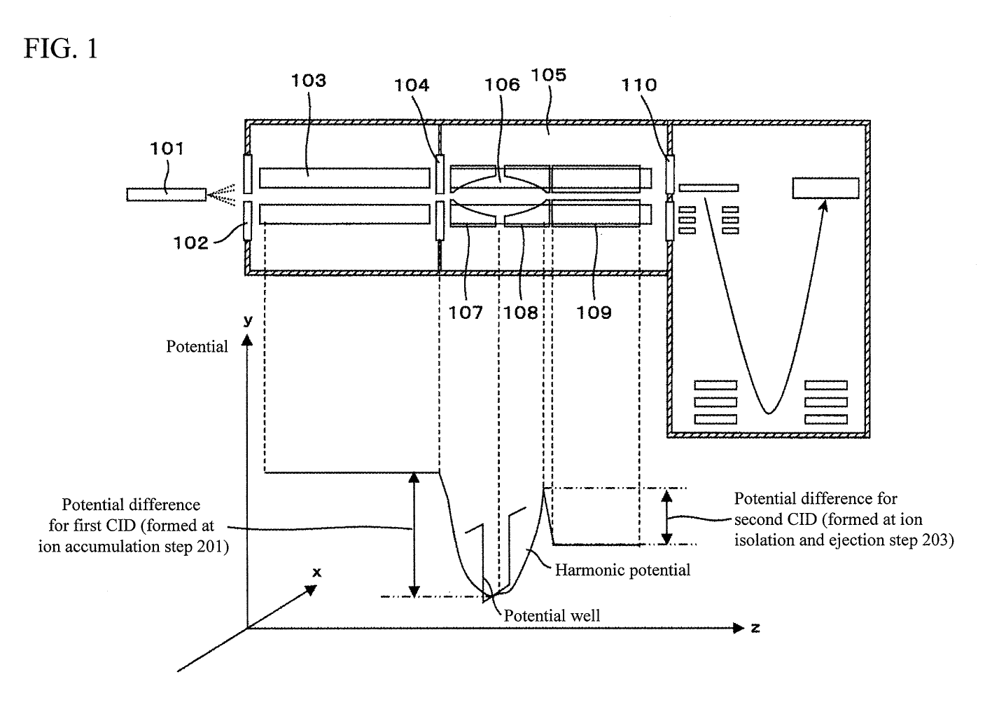

FIG. 1 is a general configuration diagram illustrating a case where this embodiment is applied to a quadrupole-time of flight mass spectrometer. To begin with, the configuration of a mass spectrometer according to this embodiment will be described. An ion source 101 ionizes the sample with a voltage of several kV applied thereto by a DC power supply. Ions charged either positively or negatively are introduced into a vacuum through a micropore 102 having a diameter of approximately 0.2 mm to 0.8 mm. A quadrupole 103 of the first stage disposed at the subsequent stage is a quadrupole to create a linear quadrupolar electric field, and applies a high-frequency voltage superimposed on the DC voltage. Controlling the voltage so as to have a constant ratio of the high-frequency voltage and the DC voltage allows ions of a particular mass-to-charge ratio to be transmitted selectively. This particular mass-to-charge ratio is made to be the mass-to-charge ratio of the target ions for the structure analysis to be performed. The target ions are the ions on which the first-round collision induced dissociation is to be performed, and are termed as target ions A. The target ions A are introduced into a collision cell 105 through an inlet micropore 104 disposed at the subsequent stage. Neutral molecules such as those of helium or of nitrogen are introduced into the collision cell 105 so that the internal pressure of the collision cell 105 is kept at approximately several militorrs. Disposed inside the collision cell 105 are: a second-stage quadrupole 106; a front vane electrode 107; a rear vane electrode 108; and a CID vane electrode 109, all of which are constituent parts of this embodiment of the present invention. The high-frequency voltage and the DC voltage are applied to the second-stage quadrupole 106. A potential well in the xy plane is created with the high-frequency voltage so as to accumulate ions in the xy directions. In addition, a voltage control is performed with the DC voltage so as to control the transmission of the ions and the cleavage of the ions. Details of this control will be described later with reference to the timing chart. A harmonic potential is created inside the front vane electrode 107 and the rear vane electrode 108 so as to accumulate ions in the z-axis direction and to perform resonance excitation. The CID vane electrode 109 is used to perform the collision induced dissociation of the second round. The voltage for the CID vane electrode 109 is controlled in a way illustrated in the timing chart to be described later.

Subsequently, description will be given of the outline of the process until the acquiring of the MS3 spectrum of this embodiment.

The target ions A having been introduced into the collision cell 105 acquire kinetic energy from the potential difference of the DC voltage between the inlet micropore 104 and the second-stage quadrupole 106. The target ions A collide with the neutral molecules so that the cleavage occurs for the first time. The cleavage of the ions occurs randomly at various positions, so that fragment ions of a wide range of the mass-to-charge ratio are produced. The fragment ions produced by the cleavage of this first time are termed as fragment ions A. The fragment ions A are accumulated in a harmonic potential created in the front vane electrode 107 and the rear vane electrode 108 and oscillate in the z-axis direction with a frequency peculiar to the mass-to-charge ratio. Then, high-frequency voltage with the vibrational frequency of the ions which are included in the fragment ions A and which are to be subjected to another structure analysis (on which the MS3 is performed) is applied to the front vane electrode 107 and the rear vane electrode 108. The high-frequency voltage is termed as an auxiliary high-frequency voltage and the ions that are to be subjected to another structure analysis are termed as target ions B. The auxiliary high-frequency voltage applied to the front vane electrode 107 has a reversed phase from the phase that the auxiliary high-frequency voltage applied to the rear vane electrode 108 has. Note that the auxiliary high-frequency voltage may be applied to only one of the front vane electrode 107 and the rear vane electrode 108. A resonance excitation in the x-axis direction of the target ions B is caused by this auxiliary high-frequency voltage, and thus the target ions B acquire energy. Now, the target ions B have a potential exceeding the harmonic potential, thus are made to exit to the side of the CID vane electrode 109. At this moment, a voltage is applied to the CID vane electrode 109, and the kinetic energy of the target ions B is increased by the potential difference between the CID vane electrode 109 and the rear vane electrode 108. When the potential difference is large enough to cause the cleavage of the target ions B, collision induced dissociation for the second time can be performed. As a consequence, fragment ions of the target ions B are produced. These fragment ions are termed as fragment ions B. These fragment ions B are made to pass through an outlet micropore 110 that serves as a barrier electrode between the collision cell 105 and the time of flight mass spectrometer 111. Subsequently, the fragment ions B are subjected to mass separation by means of the time of flight mass spectrometer 111. Thus, the mass-to-charge ratio of the fragment ions B can be measured and the MS3 spectrum can be obtained.

Subsequently, description will be given of the ion accumulation and the resonance excitation, which are the operations performed inside the harmonic potential. A potential D(z) of the z-axis direction is created on the center z-axis of the quadrupole by applying DC voltage to the front vane electrode 107 and the rear vane electrode 108. The potential D(z) of the z-axis direction is expressed by the following formula 1 using the distance z from the center between the front vane electrode 107 and the rear vane electrode 108.

$$D ( z ) \approx {D}_{0} ( \frac{z}{L} ) \qquad ( 1 )$$

In the formula, D0 is the depth of the harmonic potential; L is the distance from the center between the front vane electrode 107 and the rear vane electrode 108 to the end point of each vane electrode. When the potential of the z-axis direction causes the ions to be introduced into the harmonic potential, the ions acquire a force towards the center between the front vane electrode 107 and the rear vane electrode 108. Accordingly, the ions are made to oscillate secularly in the z-axis direction, and are then accumulated. The frequency f is expressed by the following formula 2, and is inversely proportional to the square root of the mass-to-charge ratio. In the formula, e is the elementary electric charge, n is the charge number of ion, and m is the mass of ion.

$$f = \frac{1}{2 π} \sqrt{\frac{2 enD}{m {L}^{2}}} \qquad ( 2 )$$

Application, to the vane electrode, of auxiliary AC voltage with a frequency corresponding to the mass-to-charge ratio of the ions to be subjected to the resonance excitation causes the ions to be excited in the z-axis direction. When the potential of the ions thus excited exceeds the harmonic potential, the ions are ejected outside the harmonic potential. In this event, the AC voltage has to be applied to the two vane electrodes with their respective phases that are opposite to each other. Alternatively, the AC voltage may be applied to only one of the two vane electrodes.

The voltage control described above allows the ions to be accumulated inside the harmonic potential. In addition, when the ions are subjected to resonance excitation, the ions can mass-selectively be ejected out in the z-axis direction.

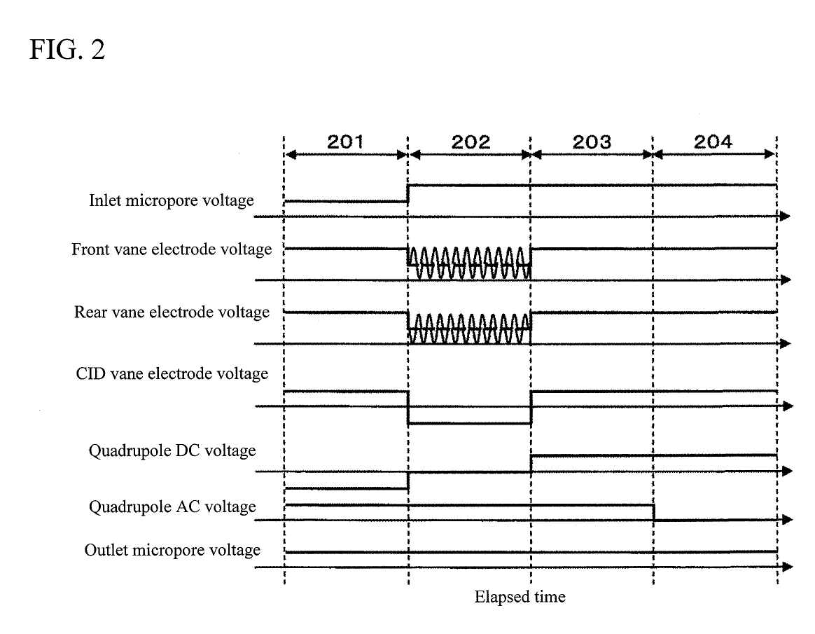

Subsequently, the voltage control of this embodiment will be described with reference to a timing chart illustrated in FIG. 2. FIG. 2 illustrates the voltage controls for the principal constituent electrodes of this embodiment of the present invention. The inlet micropore voltage, the front vane electrode voltage, the rear vane electrode voltage, the CID vane electrode voltage, and the outlet micropore voltage in FIG. 2 correspond respectively to the voltages of the inlet micropore 104, the front vane electrode 107, the rear vane electrode 108, the CID vane electrode 109, and the outlet micropore 110 shown in FIG. 1. In addition, the quadrupole DC voltage and the quadrupole AC voltage in FIG. 2 correspond respectively to the DC voltage and the AC voltage to be applied to the second-stage quadrupole 106 shown in FIG. 1.

An example of the methods of performing the MS3 will be described below. To perform the MS3 in this embodiment of the present invention, a voltage control that is divided into four steps is performed. The four steps are: an ion accumulation step 201; an ion isolation and ejection step 202; an ion transmission step 203; and an undesirable ion ejection step 204.

Detail description for these steps will be given below.

During the ion accumulation step 201, the fragment ions A are accumulated in the harmonic potential. The quadrupole AC voltage is applied at a voltage that makes the ions be accumulated in the x-direction and in the y-direction. In addition, the quadrupole DC voltage is set at a value which allows the creation of a potential difference between the inlet micropore voltage and the quadrupole DC voltage and which allows the ions to acquire enough kinetic energy to cause the cleavage of the target ions A. The quadrupole DC voltage is made variable so that an optimal voltage can be obtained for the mass-to-charge ratio of the target ions A. The DC voltage is applied as the front vane electrode voltage and as the rear vane electrode voltage, so that a harmonic potential is created in the z-axis direction. This harmonic potential gives the ions a force that makes the ions to move to the center of the harmonic potential, and thus the accumulation of the ions is accomplished.

Subsequently, the ion isolation and ejection step 202 is performed. During the ion isolation and ejection step 202, the axial resonance excitation of the ions is made to take place and the MS3 is performed by means of the potential difference between the harmonic potential and the CID vane electrode voltage. The same AC voltage is applied as the front vane electrode voltage and as the rear vane electrode voltage. In addition, an auxiliary AC voltage with a frequency that is equal to the vibrational frequency of the target ions B is superimposed. In this event, the phase of the auxiliary AC voltage for the front vane electrode is opposite to the phase of the auxiliary AC voltage for the rear vane electrode. In addition, the voltage to be applied as the inlet micropore voltage has to be capable of creating a potential that is higher than the harmonic potential. Accordingly, the target ions B are prevented from being let out to the side of the inlet micropore 104. As a consequence, resonance excitation in the z-axis direction of the target ions B is caused to take place, and the target ions B acquire an energy exceeding the harmonic potential. As a consequence, the target ions B are let out in the direction of the CID vane electrode 109. A voltage is applied to the CID vane electrode at the start of this step so that a potential difference appropriate for the cleavage of the target ions B can be obtained. Accordingly, the target ions B that have been let out from the harmonic potential acquire a kinetic energy from the potential difference between the harmonic potential and the CID vane electrode voltage. As a consequence, the cleavage for the second time takes place to produce fragment ions B.

Subsequently, the ion transmission step 203 is performed. During the ion transmission step 203, the fragment ions B produced in the above-described way are transported to the time of flight mass spectrometer 111. The CID vane electrode voltage, the quadrupole DC voltage, and the outlet micropore voltage are applied in a gradient fashion so that the fragment ions B can acquire a force that makes the fragment ions B be directed to the time of flight mass spectrometer 111. In this way, the fragment ions B are transported to the time of flight mass spectrometer 111.

Subsequently, the undesirable ion ejection step 204 is performed. During the undesirable ion ejection step 204, the undesirable ions that remain in the harmonic potential are ejected. When the quadrupole AC voltage is set at 0V, the pseudo potential well created in the x-axis direction and in the y-axis direction disappears, and thus the ions are ejected in the x-axis direction and in the y-axis direction. With this operation, the undesirable ions in the harmonic potential are ejected.

The above-described configuration of the embodiment of the present invention, and the performing of the above-described voltage control of the embodiment of the present invention enable a quadrupole-time of flight mass spectrometer to perform the MS3.

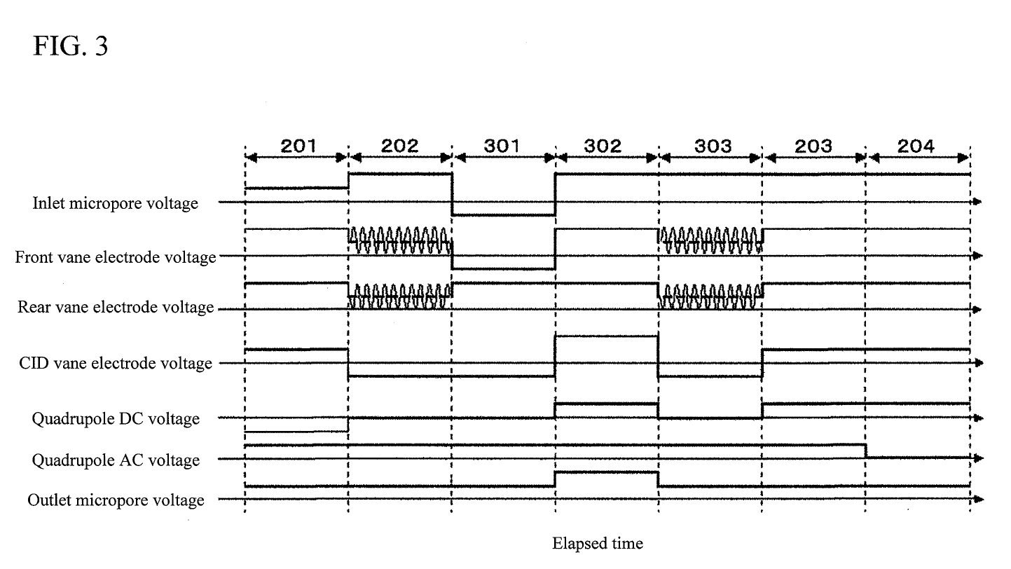

In addition, an example of the methods of performing the MSn (n≧4) will be described below. In this embodiment of the present invention, the performing of the MSn is made possible by adding other steps to the time chart shown in FIG. 2. FIG. 3 shows an example of the time charts for performing the MS4. The steps 201, 202, 203, and 204 shown in FIG. 3 are the same as their respective counterpart steps shown in FIG. 2, but an axial undesirable ion ejection step 301, a reverse transportation step 302, a second-round ion isolation and ejection step 303 are added.

After the performing of the ion isolation and ejection step 202, the axial undesirable ion ejection step 301 is performed. The axial undesirable ion ejection step 301 is a step at which the undesirable ions accumulated in the harmonic potential are ejected out to the side of the inlet micropore 104. The inlet micropore voltage and the front vane electrode voltage are outputted, in a gradient fashion, at the potentials that is opposite to the electric charge of the ions. For example, when the ions are positive ions, the voltage to be outputted is negative. In contrast, when the ions are negative ions, the voltage to be outputted is positive. The gradient voltage accelerates the undesirable ions towards the side of the inlet micropore 104, and disappears at the terminal electric field of the first-stage quadrupole 103. In this event, the high-frequency voltage of the first-stage quadrupole 103 may preferably be set at 0 V. In addition, the CID electrode voltage at this step is set at the same voltage that is set at the ion isolation and ejection step 202. Accordingly, a potential difference is created between the rear vane electrode voltage and the outlet micropore voltage. As a consequence, the fragment ions B are accumulated in the vicinity of the CID vane electrode 109.

Subsequently, the reverse transportation step 302 is performed. The reverse transportation step 302 is a step at which the fragment ions B distributed in the vicinity of the CID vane electrode 109 are returned back to the inside of the harmonic potential. The inlet micropore voltage and the front vane electrode voltage are returned back to positive voltages so that a harmonic potential can be created again. In addition, the CID vane electrode voltage and the outlet micropore voltage are set at values exceeding the rear vane electrode voltage. Accordingly, the fragment ions B are accelerated towards the harmonic potential by the potential difference between the front vane electrode voltage and the CID vane electrode voltage. As a consequence the fragment ions B are accumulated in the harmonic potential.

Subsequently, the second-round ion isolation and ejection step 303 is performed. The voltage control at the second-round ion isolation and ejection step 303 is the same as the corresponding control at the ion isolation and ejection step 202. The voltage control of this step allows the target ions among the fragment ions B to be selectively ejected and thus allows fragment ions for the MS4 to be produced.

Then, the performing of the ion transmission step 203 and the undesirable ion ejection step 204 makes it possible to obtain the mass spectrum of the MS4.

In short, the addition of the three steps—the axial undesirable ion ejection step 301, the reverse transportation step 302, and the second-round ion isolation and ejection step 303—enables the MS4 to be performed. In addition, the addition of the plural sets of the above-mentioned three steps after the second-round ion isolation and ejection step 303 enables a plural number of times MS/MS analysis to be performed.

### Embodiment 2

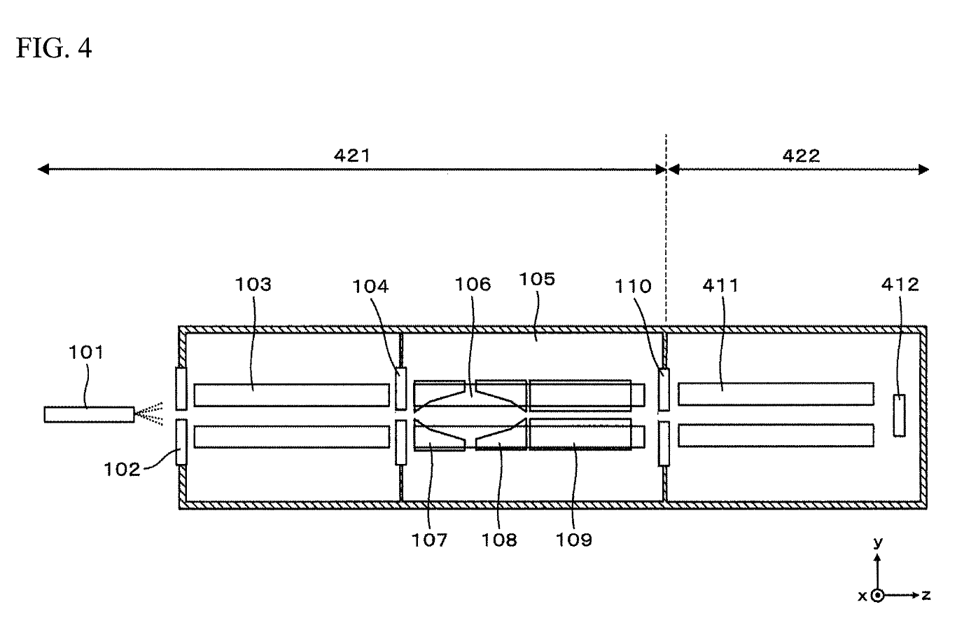

As a second embodiment, a mode of carrying out the present invention by use of a triple quadrupole mass spectrometer will be described below. FIG. 4 is a general configuration diagram of this embodiment. The configuration from the ion source 101 to the micropore 102 (a range 421 from the ion source to the outlet micropore) is the same as the corresponding configuration of Embodiment 1 described above, but the mass separator disposed at the subsequent stage is a quadrupole mass spectrometer 422 in this Embodiment 2. The quadrupole mass spectrometer includes: a third-stage quadrupole 411 to which DC voltage and AC voltage can be applied; and a detector 412 that detects ions and converts the detection results into electric-current values. With the configuration of the range 421 described in Embodiment 1 and by performing the voltage control described in Embodiment 1, the fragment ions B are produced. The fragment ions B thus produced are transported to the third-stage quadrupole 411. In the third-stage quadrupole 411, voltage sweeping is performed with a constant ratio between the AC voltage and the DC voltage, and the ions within the mass range to be observed are transported consecutively to the detector. Accordingly, the mass spectrum for the fragment ions B can be obtained.

As has been described thus far, the configuration including the quadrupole mass spectrometer 422 may be changed to a configuration including another type of mass spectrometers, such as an ion cyclotron resonance mass spectrometer (FT-ICR). Accordingly, the present invention can be carried out with the mass spectrometer that is suitable for the purpose of and for the sample of the measurement.

One of the characteristics of the configuration of the present invention is the performing of the second-round collision induced dissociation by means of the potential difference provided at the later stage. The potential difference provided at the later stage is, for example, the potential difference between the rear vane electrode 108 and the CID vane electrode 109. No such potential difference has been provided conventionally. In addition, another characteristic of the present invention includes the provision of a space at the rear of the rear vane electrode, and the provision of an electrode capable of creating or controlling the potential difference (for example, the CID vane electrode 109) at the space. In addition, no harmonic potentials are conventionally created inside the collision cell, so that the collision induced dissociation cannot be performed by use of a conventional device. Accordingly, the potential difference provided at the later stage and the forming of a harmonic potential inside the collision cell are also one of the characteristics of the configurations of the present invention. With these characteristics, the present invention brings about the following effects: (1) enabling the MS3 analysis; (2) enabling the MSn analysis (n≧4); and (3) enabling the observation of fragment ions of low mass-to-charge ratios.

Explanation of Reference Numerals

| | |
|---|---|
| 101 | ion source |
| 102 | micropore |
| 103 | first-stage quadrupole |
| 104 | inlet micropore |
| 105 | collision cell |
| 106 | second-stage quadrupole |
| 107 | front vane electrode |
| 108 | rear vane electrode |
| 109 | CID vane electrode |
| 110 | outlet micropore |
| 111 | time of flight mass spectrometer |
| 201 | ion accumulation step |
| 202 | ion isolation and ejection step |
| 203 | ion transmission step |
| 204 | undesirable ion ejection step |
| 301 | axial undesirable ion ejection step |
| 302 | reverse transportation step |
| 303 | second round of ion isolation and ejection step |
| 411 | third-stage quadrupole |
| 412 | detector |
| 421 | range from ion source to outlet micropore |
| 422 | quadrupole mass spectrometer |

What is claimed is:

1. A mass spectrometer comprising:
an ion source that ionizes a sample;
an nth-stage (n is a natural number) mass separator that performs a mass separation in which target ions are isolated from the ions produced by the ion source;
a collision cell that performs an mth-time (m is a natural number) collision induced dissociation on the isolated ions;
an (n+1)th-stage mass separator that performs another mass separation on the fragment ions produced through the collision induced dissociation; and
a detector that detects ions, wherein
a harmonic potential is created inside the collision cell,
the fragment ions produced through the collision induced dissociation are accumulated in the harmonic potential,
target ions selected from the fragment ions are selectively ejected in an axial direction, and
an (m+1)th-time collision induced dissociation is performed by means of a potential difference provided at a later stage.

2. The mass spectrometer according to claim 1, wherein n=1 and m=1.

3. The mass spectrometer according to claim 2, wherein the collision cell accumulates the ions by creating a pseudo potential well in a direction perpendicular to a direction in which the ions travel, the pseudo potential well being created by applying a high-frequency voltage to a multipole such as a quadrupole and an octapole.

4. The mass spectrometer according to claim 2, wherein the harmonic potential created in the collision cell is created in the axial direction by disposing an electrode of a flat plate shape and by applying a DC voltage to the electrode.

5. The mass spectrometer according to claim 2, wherein
an AC voltage is superimposed on a harmonic potential to excite target ions and to isolate ions to be subjected to collision induced dissociation.

6. The mass spectrometer according to claim 2, wherein energy that gives the ions the potential difference to perform a second-time collision induced dissociation is made variable by disposing an electrode of a flat plate shape after the harmonic potential and by controlling the DC voltage to be applied to the electrode.

7. The mass spectrometer according to claim 2, wherein
plural-time MSn is made executable by performing an operation of returning ions back to the harmonic potential after performing a second-time collision induced dissociation, the operation including: applying a DC voltage to a first electrode that gives the potential difference needed to perform the second-time collision induced dissociation and a second electrode provided at a stage subsequent to the first electrode, thereby setting each of the first and second electrodes to have a higher potential than the potential at an edge of the harmonic potential.

8. A mass spectrometry method comprising:
a first step of ionizing a sample;
a second step of performing a mass separation in which target ions are isolated from the ions produced by the ion source;
a third step of performing a collision induced dissociation on the selected ion;
a fourth step of performing another mass separation on fragment ions produced by the collision induced dissociation; and
a fifth step of detecting ions, wherein,
at the fourth step, a harmonic potential is created, the fragment ions produced through the collision induced dissociation are accumulated in the harmonic potential, target ions selected from the fragment ions are selectively ejected in an axial direction, and another collision induced dissociation is performed by means of a potential difference provided at a later stage.

9. The mass spectrometry method according to claim 8, wherein, at the fourth step, the ions are accumulated by creating a pseudo potential well in a direction perpendicular to a direction in which the ions travel.

10. The mass spectrometry method according to claim 8, wherein, at the fourth step, the harmonic potential is formed in the axial direction.

11. The mass spectrometry method according to claim 8, wherein, at the fourth step, an AC voltage is superimposed on a harmonic potential to excite target ions and to isolate ions to be subjected to collision induced dissociation.

12. The mass spectrometry method according to claim 8, wherein, at the fourth step, the energy that gives the ions the potential difference to perform second-time collision induced dissociation is made variable by disposing an electrode of a flat plate shape after the harmonic potential and by controlling the DC voltage to be applied to the electrode.

13. The mass spectrometry method according to claim 12, wherein the fourth step includes an operation of returning ions back to the harmonic potential after performing a second-time collision induced dissociation, the operation including: applying a DC voltage to a first electrode that gives the potential difference needed to perform the second-time collision induced dissociation and a second electrode provided at a stage subsequent to the first electrode, thereby setting each of the first and second electrodes to have a higher potential than the potential at an edge of the harmonic potential.
